(19) United States
(12) Patent Application Publication
(10) Pub. No.: US 2014/0089802 A1
(43) Pub. Date: Mar. 27, 2014

(54) METHOD, APPARATUS AND MOBILE TERMINAL FOR SWITCHING VIDEO PLAYING CONTENT

(71) Applicant: HUAWEI TECHNOLOGIES CO., LTD., Shenzhen (CN)

(72) Inventor: Yuanhui WANG, Shenzhen (CN)

(73) Assignee: HUAWEI TECHNOLOGIES CO., LTD., Shenzhen (CN)

(21) Appl. No.: 14/094,023

(22) Filed: Dec. 2, 2013

Related U.S. Application Data
(63) Continuation of application No. PCT/CN2011/076896, filed on Jul. 6, 2011.

(51) Int. Cl. G06F 3/0484

(52) U.S. Cl. CPC G06F 3/0484
USPC 715/719

(57) ABSTRACT

The present invention discloses a method, an apparatus and a mobile terminal for switching video playing content, and relates to the technical field of the mobile communication terminal and can solve the problem that the switching of the video playing content is relatively cumbersome when full-screen playing the video. The method comprises: playing current video content in a full-screen mode; displaying, after having received a trigger whereby a user switches video playing content, a current video playing list in a full-screen playing interface while keeping full-screen playing the current video content, video content being comprised in the current video playing list; and terminating, when the user selects the video content in the current video playing list, playing the current video content, and full-screen playing the video content selected by the user. The present invention is applied to switch the video playing content in the case of full-screen playing the video.

### CROSS-REFERENCE TO RELATED APPLICATIONS

This application is a continuation of International Patent Application No. PCT/CN2011/076896, filed on Jul. 6, 2011, which is hereby incorporated by reference in its entirety.

### FIELD OF THE INVENTION

The present invention relates to the technical field of the mobile communication terminal and, in particular, to a method, an apparatus and a mobile terminal for switching video playing content.

### BACKGROUND OF THE INVENTION

With the continuous development of the mobile terminal technology, a mobile terminal having a video playing function (such as, a mobile phone, a MP4 and a palmtop etc.) has been very popular. The mobile terminal having the video playing function can greatly improve a user's satisfaction, so as to enable the user to get a better experience. The user of the mobile terminal can watch an online video on demand through a network and also can watch a local video file of the mobile terminal. In the process of watching a video content, the user can exit from the current video content being played and select and watch other video content.

In the process of implementing the present invention, the inventor discovered that the following problems exist in the related art: it is not possible to switch to other video content when the current video content is being displayed in full-screen on the mobile terminal. Instead, it is first necessary to exit from a current full-screen playing interface. This process is relatively cumbersome and is not conducive to the user experience.

### SUMMARY OF THE INVENTION

Embodiments of the present invention provide a method, an apparatus and a mobile terminal for switching video playing content, such that in the case of full-screen playing video content, the switching of the video playing content can be accomplished without exiting from a current full-screen playing interface.

In order to achieve the above object, the embodiments of the present invention take the technical solution as follows:

According to an aspect, the embodiments of the present invention provide a method for switching video playing content, comprising:

displaying, after having received a trigger of a user, a current video playing list in a full-screen playing interface while keeping full-screen playing the current video content, video content being comprised in the current video playing list; and

terminating play the current video content, when user selects a video content in the current video playing list, playing the current video content, and full-screen playing the video content selected by the user.

According to another aspect, the embodiments of the present invention further provide an apparatus for switching video playing content, comprising:

a display module for displaying, after having received a trigger of a user, a current video playing list in a full-screen playing interface while keeping full-screen playing the current video content, the current video playing list comprising video content; and

a switching module for terminating play the current video content, when user selects a video content in the current video playing list, playing the current video content, and full-screen playing the video content selected by the user.

According to still another aspect, the embodiments of the present invention further provide a mobile terminal, and the mobile terminal comprises the above-mentioned apparatus for switching video playing content.

According to yet another aspect, the embodiments of the present invention further provide a video playing interface, comprising:

a first playing interface constructed by first display element for playing current video content;

a browse interface constructed by second display element for browsing a video file in a video program source, the browse interface being activated/aroused when the first playing interface playing the current video content is clicked; and

a second playing interface constructed by third display element for playing the selected video file, the second playing interface being activated/aroused when the video file in the browse interface is clicked (is selected).

The method, the apparatus, the mobile terminal and the video playing interface for switching the video playing content provided by the embodiments of the present invention can display video content included in the current playing list on the full-screen playing interface to be selected by a user while keeping full-screen playing the current video content, and switch the video content selected by the user to the full-screen playing interface to perform playing. By using the embodiments of the present invention, in the case of full-screen playing video content, the switching of the video playing content can be accomplished without exiting from the current full-screen playing interface, so as to enable the user to get a better experience.

### BRIEF DESCRIPTION OF THE DRAWINGS

To make clearer the explanation of technical solutions of the embodiments of the present invention or of the related art, the drawings needed in the description of the embodiments or the related art are briefly illustrated below. Apparently, the drawings illustrated below are merely directed to some embodiments of the present invention, and it is possible for persons ordinarily skilled in the art to deduce other drawings from these drawings without creative effort.

FIG. 1 is a flowchart illustrating a method provided according to embodiment 1 of the present invention;

FIG. 2 is a flowchart illustrating a method provided according to embodiment 2 of the present invention;

FIG. 3 is a flowchart illustrating a method provided according to embodiment 3 of the present invention;

FIGS. 4 and 5 are schematic structural diagrams illustrating an apparatus provided according to embodiment 4 of the present invention; and

FIGS. 6 and 7 are schematic diagrams illustrating a video playing interface of a mobile terminal provided according to embodiment 4 of the present invention.

### DETAILED DESCRIPTION OF THE PREFERRED EMBODIMENTS

The technical solutions according to the embodiments of the present invention are clearly and completely described below with reference to the drawings. Apparently, the embodiments as described below are merely partial, rather than entire, embodiments of the present invention. On the basis of the embodiments of the present invention, all other embodiments obtainable by persons ordinarily skilled in the art without creative effort shall all fall within the protection scope of the present invention.

### Embodiment 1

The embodiment of the present invention provides a method for switching video playing content, as shown in FIG. 1, the method comprises:

Step 101—a mobile terminal plays current video content in a full-screen mode.

Step 102—the mobile terminal displays, after having received a trigger whereby a user switches video playing content, a current video playing list in a full-screen playing interface while keeping full-screen playing the current video content, video content being comprised in the current video playing list.

Step 103—the mobile terminal terminates, when the user selects the video content in the current video playing list, playing the current video content, and full-screen plays the video content selected by the user.

In this embodiment, the mobile terminal can be, but not limited to, a mobile phone or a palmtop.

The method for switching the video playing content provided by the embodiment of the present invention can display video content included in the current playing list on the full-screen playing interface to be selected by a user while keeping full-screen playing the current video content, and switch the video content selected by the user to the full-screen playing interface to perform playing. By using the embodiments of the present invention, in the case of full-screen playing video content, the switching of the video playing content can be accomplished without exiting from the current full-screen playing interface, so as to enable the user to get a better experience.

### Embodiment 2

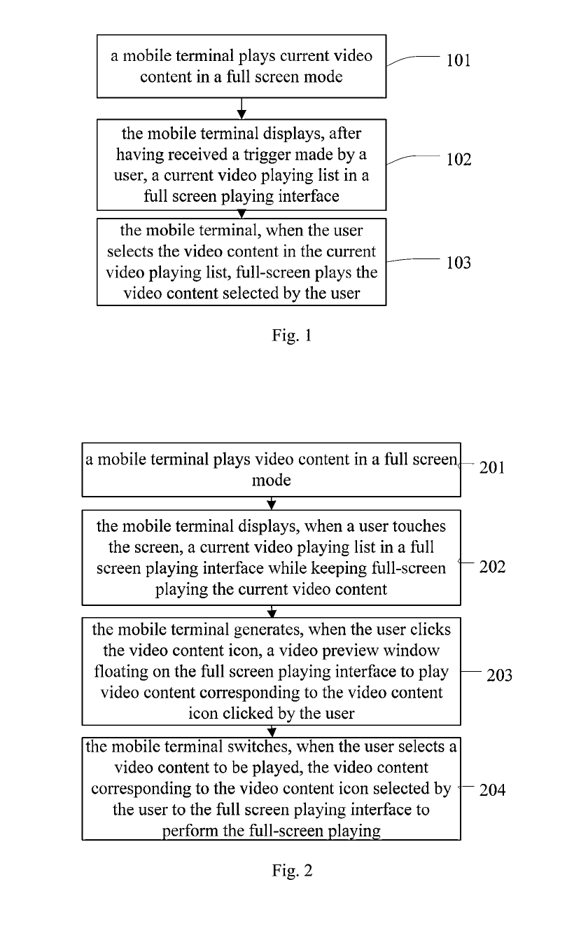

The embodiment of the present invention provides a method for switching video playing content, as shown in FIG. 2, the method comprises:

Step 201—a mobile terminal plays video content in a full-screen mode, wherein the video content can be a video source acquired through a network and can also be a local video file of the mobile terminal.

Step 202—the mobile terminal displays, when a user touches the screen, a current video playing list in a full-screen playing interface while keeping full-screen playing the current video content, video content being comprised in the current video playing list and the video content being identified by a video content icon corresponding to the video content.

In this step, the screen touching is used for triggering the mobile terminal to display the current playing list, and the user can also adopt other manners to perform the trigger, which is not limited herein; and in order to avoid affecting the user to watch the current video content being played in the mobile terminal, the current video list can be semitransparent.

Step 203—the mobile terminal generates, when the user clicks the video content icon, a video preview window floating on the full-screen playing interface to play video content corresponding to the video content icon clicked by the user.

Step 204—the mobile terminal terminates, when the user clicks again the video content icon or drag and drop the video preview window to the middle area of the full-screen playing interface, the current video content being played currently in the full-screen playing interface, switches the video content corresponding to the video content icon selected by the user to the full-screen playing interface to perform the full-screen playing, and closes simultaneously the video preview window.

In this embodiment, Step 203 is optional, which is used for performing the preview playing for the video content included in the video playing list, such that the user can select the video content to perform the full-screen playing.

The method for switching the video playing content provided by the embodiment of the present invention can display video content included in the current playing list on the full-screen playing interface to be selected by a user while keeping full-screen playing the current video content, then generate the preview window floating on the full-screen playing interface to play video content selected by the user, and finally switch the video content selected by the user to the full-screen playing interface to perform the full-screen playing. By using the embodiment of the present invention, in the case of full-screen playing video content, the switching of the video playing content can be accomplished without exiting from the current full-screen playing interface, and the video content can be performed the preview playing to be easy for the user to select the video content, so as to enable the user to get a better experience.

### Embodiment 3

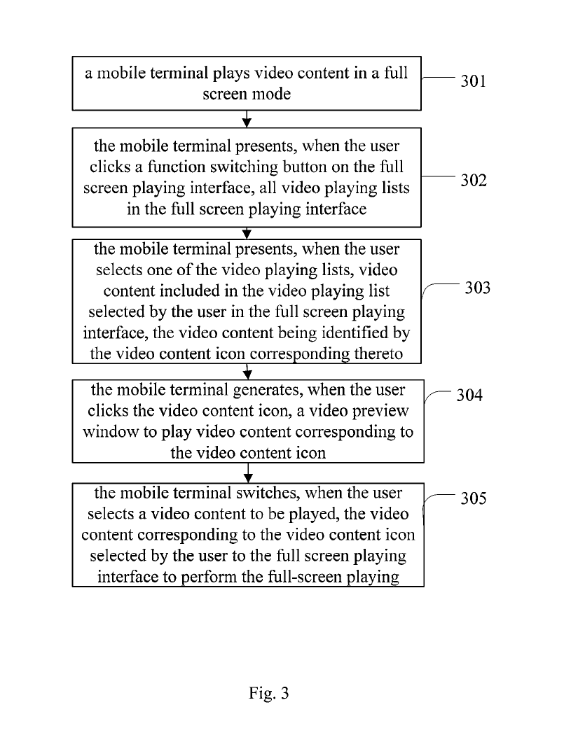

The embodiment of the present invention provides a method for switching video playing content, and as shown in FIG. 3, the method comprises the following steps:

Step 301—a mobile terminal plays video content in a full-screen mode, wherein the video content can be a video source acquired through a network and can also be a local video file of the mobile terminal.

Step 302—the mobile terminal presents, when the user clicks a function switching button on the full-screen playing interface, all video playing lists to be selected by the user while keeping full-screen playing the current video content in the full-screen playing interface.

In this step, the function switching button is used for triggering the mobile terminal to switch the video playing list, and the mobile terminal can also adopt other manners to trigger the mobile terminal to switch the video playing list, which is not limited herein.

Step 303—the mobile terminal presents, when the user selects one of the video playing lists, video content included in the video playing list selected by the user in the full-screen playing interface, the video content being identified by the video content icon corresponding to the video content.

Step 304—the mobile terminal generates, when the user clicks the video content icon, a video preview window floating on the full-screen playing interface to play video content corresponding to the video content icon clicked by the user.

Step 305—the mobile terminal terminates, when the user clicks again the video content icon or drag and drop the video preview window to the middle area of the full-screen playing interface, the current video content being played currently in the full-screen playing interface, switches the video content corresponding to the video content icon selected by the user to the full-screen playing interface to perform the full-screen playing, and closes simultaneously the video preview window.

The method for switching the video playing content provided by the embodiment of the present invention can display, on the full-screen playing interface, all video playing lists to be selected by a user while keeping full-screen playing the current video content, then display video content included in the video playing list according to the user's selection, the video content being identified by a video content icon corresponding to the video content, and switch the video content selected by the user to the full-screen playing interface to perform the full-screen playing. By using the embodiment of the present invention, in the case of full-screen playing video content, the video list can be switched without exiting from the current full-screen playing interface, and the video content can be performed the preview playing to be easy for the user to select and finally the video content selected by the user can be performed the full-screen playing, so as to enable the user to get a better experience.

### Embodiment 4

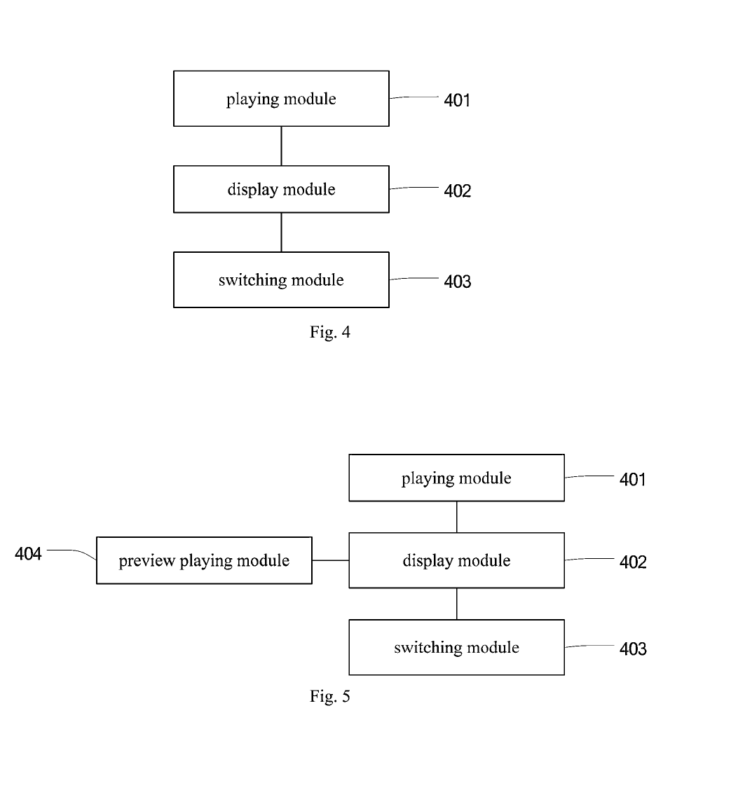

The embodiment of the present invention provides an apparatus for switching video playing content, and as shown in FIG. 4, the apparatus comprises a playing module 401, a display module 402 and a switching module 403, wherein:

the playing module 401 is configured for playing current video content in a full-screen mode;

the display module 402 is configured for displaying, after having received a trigger whereby a user switches video playing content, a current video playing list in a full-screen playing interface while keeping full-screen playing the current video content, the current video playing list comprising video content; and

the switching module 403 is configured for terminating play the current video content, when user selects a video content in the current video playing list, playing the current video content, and full-screen playing the video content selected by the user.

Further, as shown in FIG. 5, the apparatus further comprises a preview playing module 404 for generating, when the user clicks a video content icon in the current video playing list, a video preview window floating on the full-screen playing interface to play video content corresponding to the clicked video content icon.

In particular, the switching module 403 is particularly configured for terminating the current video content being played currently in the full-screen playing interface, when a user clicks again a video content icon in the current video playing list or drag and drop a video preview window to the middle area of the full-screen playing interface, switching the video content corresponding to the video content icon selected by the user to the full-screen playing interface to perform the full-screen playing, and closing simultaneously the video preview window.

Further, the display module 402 is particularly configured for displaying on the full-screen playing interface, after having received a trigger whereby the user switches a video playing list, all video playing lists to be selected by the user; and

further, the display module 402 is further configured for presenting, when the user selects one of the video playing lists, video content included in the video playing list selected by the user in the full-screen playing interface, the video content being identified by the video content icon corresponding to the video content.

In the apparatus for switching the video playing content provided by the embodiment of the present invention, the playing module 401 full-screen plays the current video content; the display module 402 displays the video content icon included in the current video playing list or all of the video playing lists; the preview playing module 404 preview plays the video content to be previewed which is selected by the user; and finally the switching module 403 switches the video content to be played which is selected by the user to the full-screen playing interface to perform the full-screen playing. By using the apparatus provided by the embodiment of the present invention, in the case of full-screen playing video content, the playing list can be switched without exiting from the current full-screen playing interface, and the video content can be performed the preview playing to be easy for the user to select and finally the video content selected by the user can be performed the full-screen playing, so as to enable the user to get a better experience.

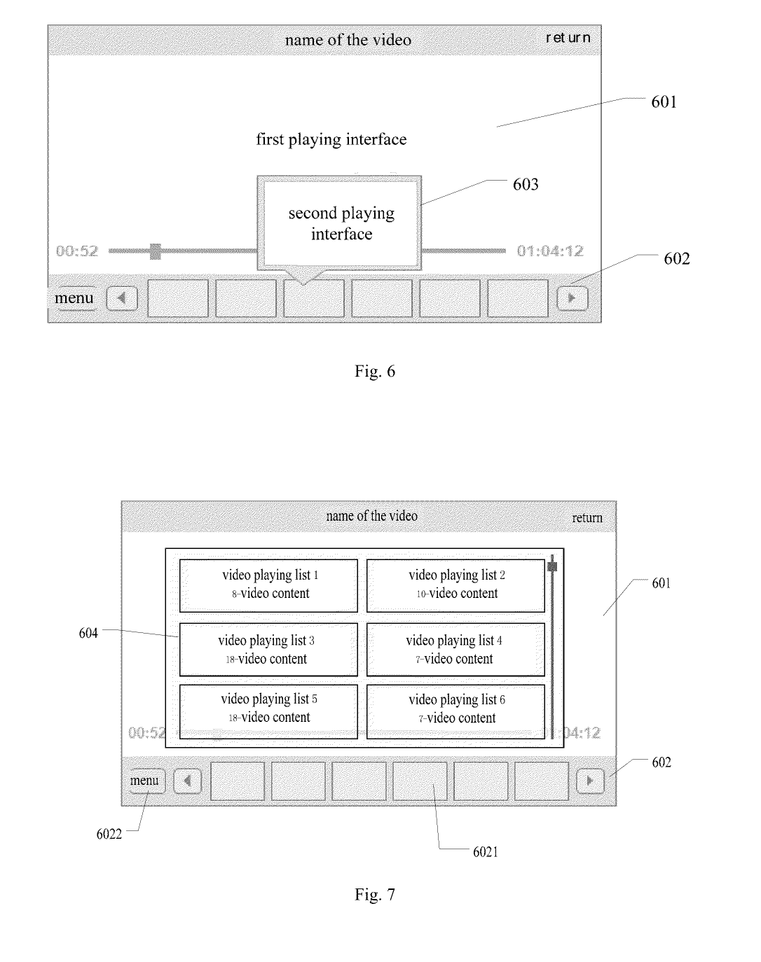

The embodiment of the present invention further provides a mobile terminal, and the mobile terminal comprises, but is not limited to, the apparatus for switching video playing content as shown in FIG. 4 or 5. A video playing interface of the mobile terminal is shown in FIG. 6: wherein in the case of having received a user's trigger (such as clicking the screen), in the state of full-screen playing a video, a current video playing list is displayed and video content included in the current video playing list can be performed the preview playing to be easy for the user to select the video content to perform the full-screen playing; and in addition to this situation, the video playing interface of the mobile terminal can also be shown in FIG. 7: wherein in the case that the user clicks a function switching button, all of the video playing lists are displayed on the full-screen playing interface to be selected by the user and the video content included in the video playing list selected by the user is displayed. The particular implementation of the mobile terminal provided by the embodiment of the present invention refers to the above-described embodiment, which is not redundantly described here.

### Embodiment 5

The embodiment of the present invention provides a video playing interface, and the video playing interface can be presented on a display apparatus of a handheld terminal device. As shown in FIG. 6 of the fourth embodiment, the video playing interface comprises: a first playing interface 601, a browse interface 602 and a second playing interface 603, wherein:

The first playing interface 601 is constructed by first display element and is configured for playing current video content.

Preferably, the first playing interface 601 can cover the entire screen, thereby full-screen playing current video content.

When the first playing interface 601 is clicked, the browse interface 602 constructed by second display element is activated/aroused, and the browse interface 602 is configured for browsing a video file in a video program source.

Preferably, the first playing interface 601 can be reconstructed by modifying the first display element, so as to set aside a part of area within the area occupied by the first playing interface 601 as a browse area, the browse area being configured for presenting the browse interface 602.

When the video file in the browse interface 602 is clicked (is selected), the second playing interface 603 constructed by third display element is activated/aroused, the second playing interface 603 being configured for playing the selected (clicked) video file.

Preferably, the second playing interface 603 can cover a part of area of the first playing interface 601, so as to float in the first playing interface 601 to play the video file which is clicked (selected) by the user in the browse interface 602. The second playing interface 603 is correlated with the video file clicked (selected) by the user in the browse interface 602 by a visualized feature.

When the second playing interface 603 is clicked or dragged to a position near the first playing interface 601, a video program being played in the first playing interface 601 is terminated, the video file being played in the second playing interface 603 is played in the first playing interface 601, and the second playing interface 603 is concealed simultaneously.

Further, as shown in FIG. 7 of the fourth embodiment, the browse interface 602 can comprise a file browsing area 6021 and a control area 6022, the file browsing area 6021 being configured for presenting a video file in a video program source in a visualized mode and the control area 6022 comprising function control presented in the visualized mode. When detecting the function control is clicked (selected) by the user, a control interface 604 constructed by fourth display element is activated/aroused, the control interface 604 being correlated with a video playing interface and the video playing interface comprising the first playing interface 601 and the second playing interface 603. The user can set relevant settings of the video playing interface through the control interface 604, and the relevant settings comprise, but are not limited to, the brightness, the contrast, the color of the video playing interface and the progress of the current playing video.

Further, the control interface 604 floats in the first playing interface 601, and it is configured for presenting all of the video playing lists included in the video program source to be selected by the user and displaying video content included in the video playing list selected by the user in the browse area 6021 of the browse interface 602.

It should be noted that the first display element, the second display element, the third display element and the fourth display element are capable of being modified. The display element comprises, but is not limited to, a size element for defining the size of the display interfaces, color element, a transparency element and a shape element.

As can be clearly known to persons skilled in the art from the above descriptions of the embodiments, the present disclosure can be carried out with the aid of software with the indispensable general hardware mode, and can of course be carried out alone by hardware, but the former mode is preferred in many instances. Based on such understanding, the technical solution of the present disclosure or the part of the disclosure that makes contribution to the prior art can be essentially embodied in the form of a software product. Such a computer software product is stored in a readable storage medium such as a floppy disk, a hard disk or a compact disk etc, and includes a multiplicity of instructions enabling a computer device (which can be a personal computer, a server, or a network device, and so on) to execute the methods as recited in the various embodiments of the present disclosure.

The above are directed merely to preferred embodiments of the present disclosure, but the protection scope of the present disclosure is not limited thereto. Any modifications or substitutions easily conceivable to those skilled in the art within the technical scope as disclosed in the present disclosure should all be covered in the protection scope of the present disclosure. As such, the protection scope of the present disclosure should be based on the attached claims.

What is claimed is:

1. A method for switching video playing content, comprising:
playing current video content in a full-screen mode;
displaying, after receiving a trigger signaling that a user wants to switch video playing content, a current video playing list in a full-screen playing interface while keeping playing the current video content in full-screen; and
terminating playing the current video content when the user selects a new video content in the current video playing list, and
playing the new video content selected by the user in full-screen.

2. The method for switching video playing content according to claim 1, wherein the video content in the current video playing list is identified by a video content icon corresponding to the video content; further comprising:
generating, when the user clicks on the video content icon in the current video playing list, a video preview window floating on the full-screen playing interface to play video content corresponding to the clicked video content icon.

3. The method for switching video playing content according to claim 2, wherein the terminating playing the current video content when the user selects the new video content in the current video playing list, and full-screen playing the new video content selected by the user comprises:
terminating, when the user clicks again on the video content icon in the current video playing list or drags and drops the video preview window to an middle area of the full-screen playing interface, the current video content being played currently in the full-screen playing interface, switching the video content corresponding to the video content icon selected by the user to the full-screen playing interface to perform the full-screen playing, and closing the video preview window.

4. The method for switching video playing content according to claim 2, further comprising:
presenting, after having received a trigger by which the user switches a video playing list, all video playing lists to be selected by the user while keeping playing the current video content in the full-screen playing interface; and
presenting video content included in the video playing list selected by the user in the full-screen playing interface, when the user selects one of the all video playing lists, the video content being identified by the video content icon corresponding to the video content.

5. An apparatus for switching video playing content, comprising:
a playing module, configured to play current video content in a full-screen mode;
a display module, configured to display, after having received a trigger whereby a user switches video playing content, a current video playing list in a full-screen playing interface while keeping playing the current video content in full-screen; and
a switching module, configured to terminate playing the current video content when the user selects a new video content in the current video playing list, and play the new video content selected by the user in full-screen.

6. The apparatus for switching video playing content according to claim 5, wherein the video content in the current video playing list displayed by the display module is identified by a video content icon corresponding to the video content; further comprising:
a preview playing module, configured to generate, when the user clicks on the video content icon in the current video playing list, a video preview window floating on the full-screen playing interface to play video content corresponding to the clicked video content icon.

7. The apparatus for switching video playing content according to claim 6, wherein the switching module is further configured to terminate playing the current video content when the user clicks again on the video content icon in the current video playing list or drags and drops the video preview window to a middle area of the full-screen playing interface, the current video content being played currently in the full-screen playing interface, switch the video content corresponding to the video content icon selected by the user to the full-screen playing interface to perform the full-screen playing, and close the video preview window.

8. The apparatus for switching video playing content according to claim 6, wherein the display module is further configured to display, after having received a trigger by which the user switches a video playing list, all video playing lists to be selected by the user in the full-screen playing interface; and
the display module is further configured to present video content included in the video playing list selected by the user in the full-screen playing interface, when the user selects one of the all video playing lists, the video content being identified by the video content icon corresponding to the video content.

9. A mobile terminal, wherein the mobile terminal comprises the apparatus for switching video playing content,
wherein the apparatus comprises:
a playing module, configured to play current video content in a full-screen mode;
a display module, configured to display, after having received a trigger whereby a user switches video playing content, a current video playing list in a full-screen playing interface while keeping playing the current video content in full-screen; and
a switching module, configured to terminate playing the current video content when the user selects a new video content in the current video playing list, and play the new video content selected by the user in full-screen.

10. A video playing interface, comprising:
a first playing interface constructed by a first display element configured to play current video content;
a browse interface constructed by a second display element configured to browse a video file in a video program source, the browse interface being activated/aroused when the first playing interface playing the current video content is clicked on by a user; and
a second playing interface constructed by a third display element, configured to play the selected video file, the second playing interface being activated/aroused when the video file in the browse interface is clicked on or selected by a user.

11. The video playing interface according to claim 10, wherein the browse interface is presented in a browse area of the first playing interface, the browse area being a part of an area set aside, by modifying the first display element, within the area occupied by the first playing interface.

12. The video playing interface according to claim 11, wherein the second playing interface floats on the first playing interface and covers a part of the first playing interface, and the second playing interface is correlated with the selected video file in the browse interface by a visualized feature.

13. The video playing interface according to claim 11, wherein the browse interface comprises a file browsing area and a control area, the file browsing area presenting a video file in the video program source in a visualized mode, the control area comprising function control presented in the visualized mode; the function control are configured to activate a control interface constructed by a fourth display element which is correlated with the video playing interface; and the control interface floats on the first playing interface.

14. The video playing interface according to claim 12, wherein the browse interface comprises a file browsing area and a control area, the file browsing area presenting a video file in the video program source in a visualized mode, the control area comprising function control presented in the visualized mode; the function control are configured to activate a control interface constructed by a fourth display element which is correlated with the video playing interface; and the control interface floats on the first playing interface.

15. The video playing interface according to claim 11, wherein when the second playing interface is clicked on or dragged to a position near the first playing interface, a video program being played in the first playing interface is terminated, the selected video file played in the second playing interface is played in the first playing interface, and the second playing interface is concealed.

16. The video playing interface according to claim 12, wherein when the second playing interface is clicked on or dragged to a position near the first playing interface, a video program being played in the first playing interface is terminated, the selected video file played in the second playing interface is played in the first playing interface, and the second playing interface is concealed.
